(19) United States
(12) Patent Application Publication
(10) Pub. No.: US 2009/0116945 A1
(43) Pub. Date: May 7, 2009

(54) LOAD-LIFTING MEMBER WITH BOLTED JOINT

(75) Inventors: Brian Sinclair White, Heidelberg (AU); Dean Clark Jordan, Boring, OR (US); Anthony Paul Keagbine, Milwaukie, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(73) Assignee: Cascade Corporation, Fairview, OR (US)

(21) Appl. No.: 11/935,555

(22) Filed: Nov. 6, 2007

(51) Int. Cl. B66F 9/14

(52) U.S. Cl. 414/667; 414/663

(57) ABSTRACT

Improved bolted joint designs are used for a joint between a bolt-on load-lifting member such as a fork or clamp arm and a carriage or carrier associated with a material handling device. In various embodiments, an elongate rear vertical shank of one or the other of the load-lifting member or the carrier may have a plurality of mounting bolt holes spaced longitudinally along its length, each mounting bolt hole extending from a respective recessed area formed in one or both of the joined surfaces. Each bolt hole has a respective bolt-hole width dimension transverse to the elongate member, and each recessed area has a recess width dimension parallel to and greater than the bolt-hole width dimension.

### BACKGROUND OF THE INVENTION

This disclosure relates generally to bolted joints for use with material handling equipment and, more particularly, to improved bolted joint designs applicable for a joint between a bolt-on type load-lifting member, such as a fork or clamp arm, and a carriage or fork carrier.

Material handling equipment used for moving palletized or non-palletized loads from place to place, such as, for example, in a warehouse, typically includes forklift trucks or other types of vehicles equipped with material handling attachments having load-lifting members such as forks or clamp arms. For example, on a typical forklift truck, the load-lifting forks are attached to a carriage (or fork carrier) which is in turn movably attached to a mast. The carriage travels vertically along the mast for raising and lowering the forks. The carriage typically comprises flat metal surfaces upon which the forks are mounted using hooks, pins (or shafts), or bolts.

Various different types of material handling attachments may be attached to the carriage. For example, a fork-carrying side-shifter, fork positioner, load clamp, or multiple load handler attachment may be attached to the carriage. Instead of attaching the load-lifting forks on clamp arms directly to the carriage, each load-lifting member may be attached to a carrier associated with the attachment. Similar to the carriage, the carrier often comprises flat metal surfaces upon which the forks or clamp arms are mounted.

Different types of load-lifting forks and clamp arms are available and may be engineered for particular applications. For example, drum-clamping forks may incorporate contours particularly useful for clamping barrels or drums. Folding forks may be used to enable lift trucks to maneuver in areas where movement is restricted, such as, for example, in elevators. Spark retardant forks may incorporate special coatings for use in hazardous locations and atmospheres. Similarly, clamp arms may be engineered differently for handling rectangular or cylindrical loads.

Most forks and clamp arms are used in pairs, and most are attached to a carriage or a carrier using one of the above-mentioned three basic methods. The method of attachment used may be dictated by the make and model of the particular carriage or carrier or selected for other reasons. In some applications bolt-on type load-lifting members may be easier to install or adapt to various carriages or carriers. Generally, bolt-on type load-lifting members are intended to diminish unintended movement of the members when loaded or when the lift truck is in motion by providing a more rigid connection to the carriage or carrier.

A conventional bolt-on type of load-lifting fork 100 is illustrated in FIG. 1 and generally comprises an elongate blade 102, upon which a load may be supported, that extends longitudinally from a heel portion 104 to a tip 106. An elongate shank (or upright) 108 extends longitudinally from the heel portion 104 in a direction substantially perpendicular to the blade 102 and has a front face 110 which faces toward the tip 106 of the blade 102 and a back side 112 opposite to the front face 110. The shank 108 includes a plurality of bolt holes 114 extending from the front face 110 of the shank 108 toward the back side 112. The bolt holes 114 are generally spaced longitudinally along the shank 108. As shown, the bolt holes 114 are spaced along the shank 108 between the heel portion 104 and a shank top 116.

Usually, the fork 100 is bolted all the way up the shank 108 and can either be bolted on from the front face 110 or from the back of the carrier (not shown). If fitted from the front face 110, the bolt holes 114 may be counter-bored to avoid projection of the bolt heads from the front face 110 and, consequently, avoid damage that may otherwise occur to product that comes into contact with the front face 110 of the fork 100.

The bolt-on design is intended to reduce deflection in the shank 108 of the fork 100 due to the weight of the load, thus reducing the overall deflection. However, other types of loading cause increased stresses. Pin-wheeling, for example, is a method of improving the stability of stacked loads by turning alternating pallets 90 degrees with respect to each other. When a forklift operator uses the sides (or flanks) 118, 120 or tip 106 of the fork for pin-wheeling loaded pallets, or to move or reposition palletized or non-palletized loads sitting on a warehouse floor, alternating side loads such as 122, 124 are applied to the blade 102 causing deflection in the blade 108 and shank 108. Over time, even without extraordinarily rigorous use, the mounting bolts attaching the fork shank 108 to the carriage or fork carrier will develop stress fractures due to the reciprocating bending forces imposed on the bolts by the alternating side loads 122 and 124, causing the bolts to fracture within a relatively short period of time. A similar problem exists in the case of bolt-on clamp arms.

### BRIEF DESCRIPTION OF THE SEVERAL DRAWINGS

For a more complete understanding of the present invention, the drawings herein illustrate examples of the invention. The drawings, however, do not limit the scope of the invention. Similar references in the drawings indicate similar elements.

FIG. 1 is a perspective view of a conventional bolt-on fork used with material handling equipment.

FIG. 2 is a perspective view of an exemplary multiple load handler attachment including four forks spread apart for handling multiple side-by-side pallets

FIG. 3 is a perspective view of the multiple load handler attachment of FIG. 2 configured for handling single or single stacked pallets.

FIG. 4 is a perspective view of an exemplary bolt-on fork having interconnected recessed areas forming a slot.

FIG. 5 is a sectional view of a shank of the bolt-on fork of FIG. 4.

FIG. 6 is a side view of the bolt-on fork of FIG. 4.

FIG. 7 is a perspective view of the slotted bolt-on fork of FIG. 4 mounted to a carrier.

FIG. 8 is an exaggerated sectional view of an exemplary joint between a bolt-on fork having no recessed area, and a carrier.

FIG. 9 is an exaggerated sectional view of an exemplary joint between a bolt-on fork having a recessed area, and a carrier.

FIG. 10 is a perspective view of an exemplary bolt-on fork having both interconnected and non-interconnected recessed areas.

FIG. 11 is an exaggerated sectional view of an exemplary joint between a carrier having a recessed area, and a bolt-on fork.

FIG. 12 is a perspective view of an exemplary bolt-on load clamp arm having interconnected recessed areas forming a slot.

### DETAILED DESCRIPTION OF PREFERRED EMBODIMENTS

In the following detailed description, numerous specific details are set forth in order to provide a thorough understanding of the preferred embodiments. However, those skilled in the art will understand that the present invention may be practiced without these specific details, that the present invention is not limited to the depicted embodiments, and that the present invention may be practiced in a variety of alternate embodiments. In other instances, well known methods, procedures, components, and systems have not been described in detail.

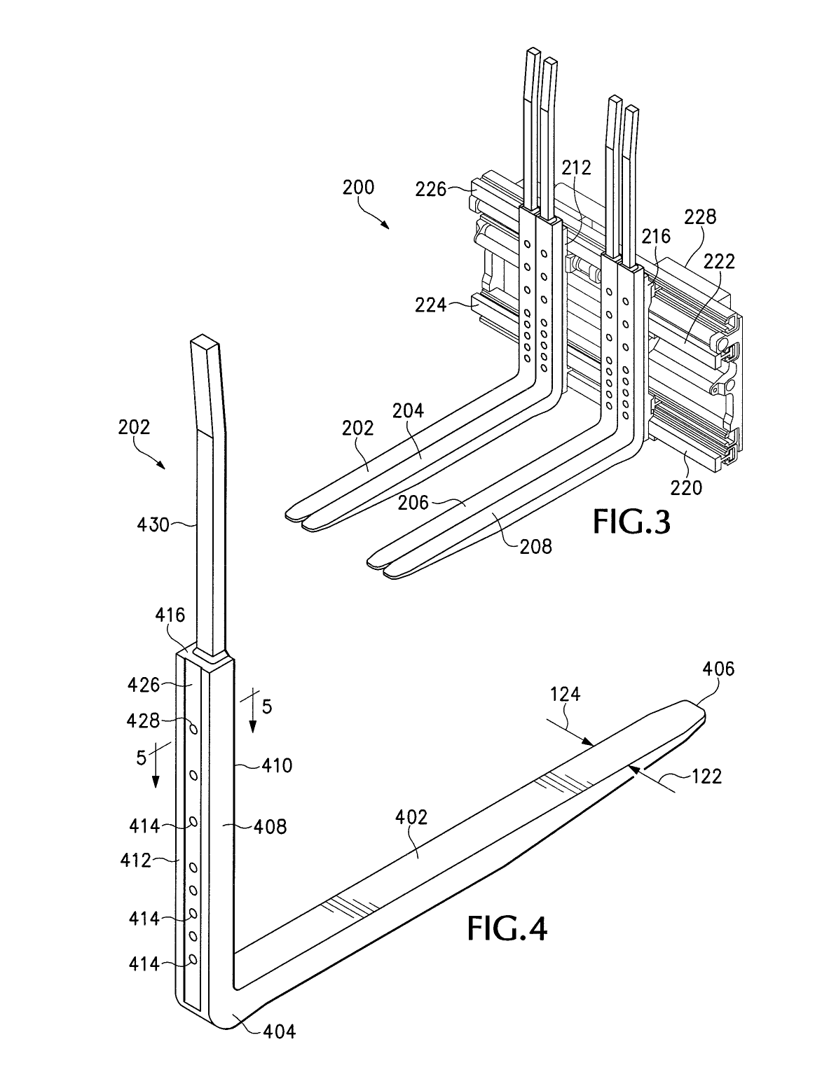

As an overview, the preferred embodiments generally involve improved bolted joint designs applicable for a joint between a bolt-on type load-lifting fork or clamp arm and a carriage or carrier. Although the present invention may be implemented in a wide variety of configurations involving different types of material handling attachments, the following detailed description discloses the preferred embodiments principally in the context of an exemplary multiple load handler attachment 200 illustrated in FIGS. 2 and 3. FIG. 2 is a perspective view of the multiple load handler attachment 200 that includes four bolt-on type forks 202, 204, 206, 208 that are spread apart for handling multiple side-by-side pallets. For example, two of the forks 202, 204 on one side of the multiple load handler 200 may be engaged with a first palletized load, and two forks 206, 208 on the other side of the multiple load handler 200 may be simultaneously engaged with a second palletized load adjacent to the first. FIG. 3 is a perspective view of the multiple load handler attachment 200 with the forks moved inward for handling single or stacked single pallets. In this single pallet handler configuration, the outer forks 202, 208 have been moved immediately adjacent to the inner forks 204, 206, and the two paired forks 202/204, 206/208 may be selectively spaced apart for handling the single pallet load.

Although the multiple load handler 200 shown in FIGS. 2 and 3 is configured as a single-double type multiple pallet handler, other configurations are available for handling up to six pallets at a time, three pallets side-by-side by two pallets deep. Such multiple load handlers are intended to be versatile for use across different industries and in various settings.

Each of the forks 202, 204, 206, 208 may be bolted to a respective carrier 210, 212, 214, 216 using a plurality of mounting bolts extending through bolt holes 218 in the shank or upright portion of the forks. Each of the respective carriers 210, 212, 214, 216 may be attached to various slidably adjustable structural members, as shown. Finally, the back side 228 of the multiple load handler attachment 200 may be attached to a forklift carriage (not shown) using conventional carriage mountings.

For example, the fork 208 and fork carrier 216 on one side may be attached to one pair of slide bar members 224, 226 and the fork 202 and carrier 210 on the opposite side may be attached to another pair of slide bar members 220, 222 in such a way that permits the two outermost forks 202, 208 to be slidably repositioned to be immediately adjacent to respective ones of the innermost forks 204, 206. The innermost forks 204, 206 and their respective carriers 212, 214 may be similarly attached so that the distance between the innermost forks 204, 206 may be adjusted.

FIG. 4 is a perspective view of a bolt-on fork 202 according to one embodiment of the invention. As shown, the bolt-on load-lifting fork 202 comprises an elongate blade 402, upon which a load may be supported, that extends longitudinally from a heel portion 404 to a tip 406. An elongate shank (or upright) 408 extends longitudinally from the heel portion 404 in a direction substantially perpendicular to the blade 402 and has a front face 410 which faces toward the tip 406 of the blade 402 and a back side 412 opposite to the front face 410. The shank 408 includes a plurality of bolt holes 414 extending from a respective back-side recessed area 426 formed in the back side 412 of the shank 408 toward the back side 412. The bolt holes 414 are generally spaced longitudinally along the shank 408. As shown, the bolt holes 414 are spaced along the shank 408 between the heel portion 404 and a shank top 416. The fork 202 may also be fitted with an arm bar 430 that extends upward from the shank top 416 and provides the forklift operator with a visual reference for repositioning the fork 202.

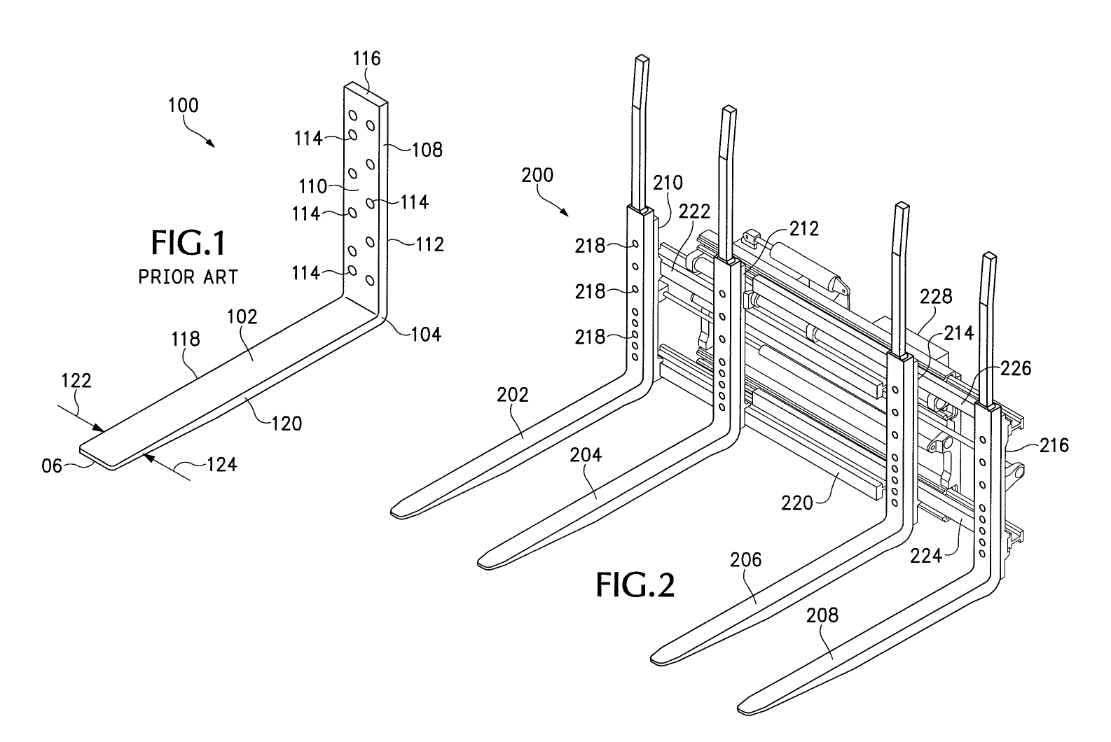

The present inventors have discovered that incorporation of respective back-side recessed areas for each bolt hole 414, interconnected as illustrated in FIG. 4 to form an elongate slot 426 extending longitudinally from the heel portion 404 to the shank top 416 along the back side 412 of the shank 408, increases the life of the bolts used to mount the fork 202 to the carrier 210 by as much as ten times when subjected to repeated, alternating side loads such as 122 and 124 shown in FIG. 1. As will be described in further detail, the inventors believe that incorporation of the back-side recessed areas whether or not interconnected to form a slot, adjusts distribution of the clamp loads of each mounting bolt. The recessed areas, whether positioned on the back side 412 of the shank 408 or the mounting surface of the carrier 210 or both, create a space between the back side 412 and the mounting surface of the carrier 210, and each mounting bolt used for mounting the fork 202 to the carrier 210 passes through such space created by each recessed area. The inventors further believe that when a mounting bolt is tightened across a respective recessed area, the bolt tends to resist bending loads imposed by side loads, such as 122 and 124 in FIG. 1, through a larger effective moment arm than would be possible without the recessed area, thereby imposing loads on the bolt more in tension than in bending and thus reducing the formation of stress fractures.

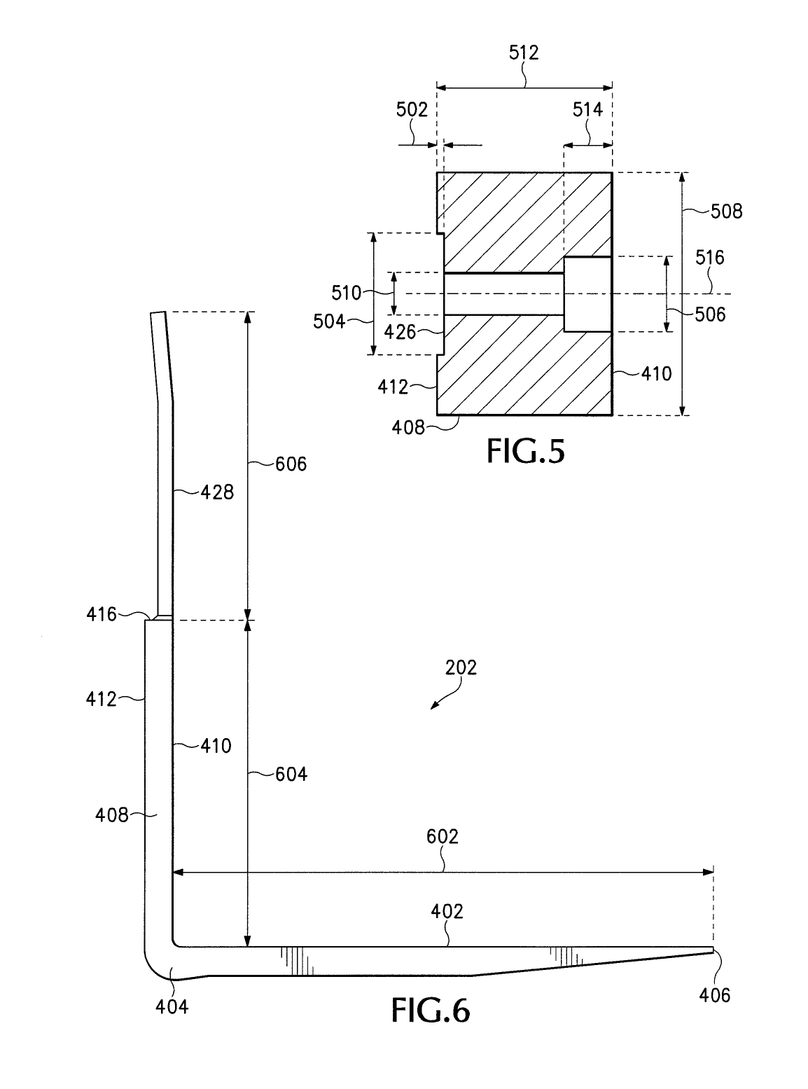

FIG. 5 provides a sectional view of the shank 408 at the bolt hole 428 identified in FIG. 4 and may be representative of sectional views at each of the bolt holes 414. As shown, the recessed area 426 has a depth dimension 502 parallel to a bolt centerline 516 extending from the back side 412 of the shank 408 to the front face 410. The recessed area 426 also has a width dimension 504 transverse to the elongate shank 408 and parallel to a bolt-hole width dimension 510. In a preferred embodiment, the recessed area width dimension 504 is greater than the bolt-hole dimension 510. Preferably, the recessed area width dimension 504 is also greater than the largest diameter of the bolt used in the bolt hole 428. As a further preference, the recessed area width dimension 504 is greater than the maximum head dimension of the bolt used in the bolt hole 428, where the diameter and maximum head dimensions are transverse to the elongate shank 408 and parallel to the bolt-hole width dimension 510. In a preferred embodiment, and as shown, the recessed area 426 has a width dimension 504 that is substantially at least one-half as long as the shank width dimension 508, where the shank width dimension 508 is transverse to the elongate shank 408 and parallel to the bolt-hole width dimension 510. Also in a preferred embodiment, and as shown, the elongate shank 408 has a shank width dimension 508 parallel to the back-side recess width dimension 504, and the bolt holes 414, 428 are substantially centrally located relative to the shank width dimension 508.

The shank 408 has a depth dimension 512 parallel to the bolt centerline 516 extending from the back side 412 of the shank 408 to the front face 410. The bolt hole 428 may be counter-bored or counter-sunk so that the mounting bolt does not project outward beyond the front face 410 of the shank 408. In one embodiment, each bolt hole 414, 428 communicates with a respective front-face recessed area (or counter-bore) formed in the front face 410 of the shank 408 and has a front-face recess width dimension 506 parallel to and greater than the bolt-hole width dimension 510 but less than the recessed area width dimension 504.

In various embodiments, one or more of the following dimensions apply: the recess depth dimension 502 is 2.0+0.5/−0 mm; the back-side recess area width dimension 504 is 40±0.5 mm; the front-face recess width dimension 506 is 26±0.8 mm; the shank width dimension 508 is approximately 80 mm; the bolt-hole width dimension 510 is 17±0.25 mm; the shank depth dimension 512 is 58±0.8 mm; and a depth of counter-bore (or depth of front-face recess) dimension 514 is 17±0.8 mm.

FIG. 6 is a side view of the bolt-on fork 202 in FIG. 4. In various embodiments, one or more of the following dimensions apply: the blade length dimension 602 is approximately 1150 mm; the shank length dimension 604 is 690±1 mm; and the arm bar length dimension 606 is approximately 710 mm.

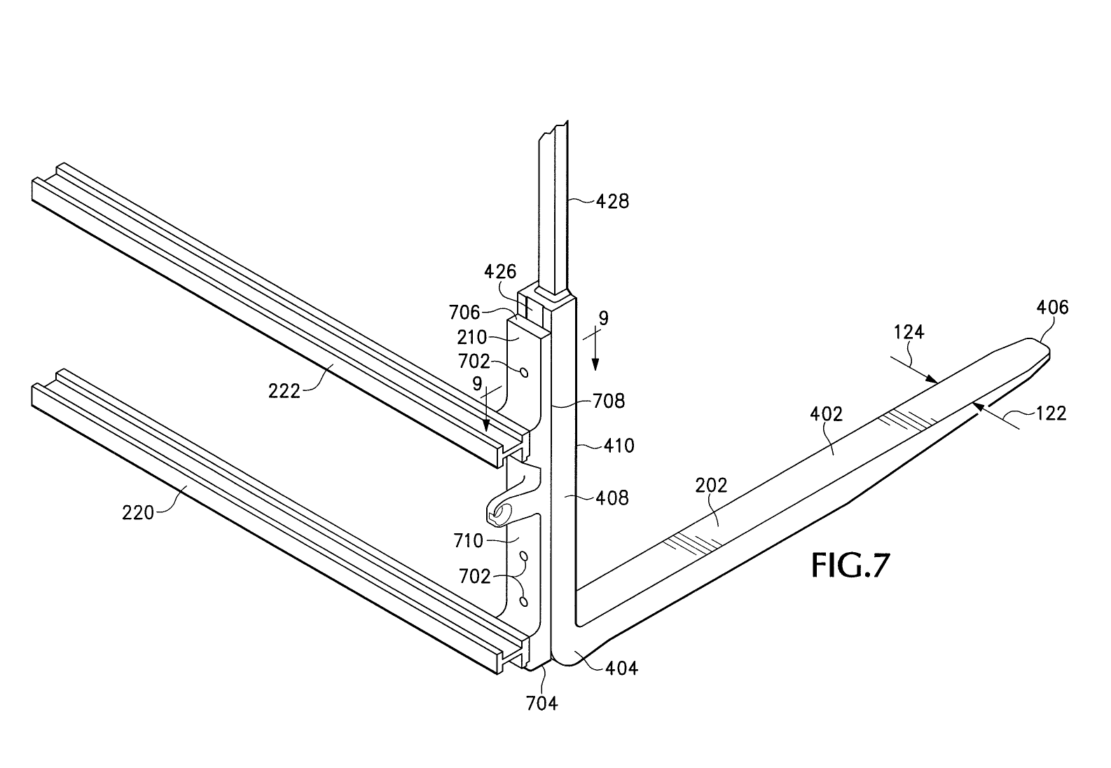

FIG. 7 provides a perspective view of a bolt-on fork 202 mounted to a carrier 210. As shown, the carrier 210 comprises an elongate carrier member extending longitudinally from a first end 704 to a second end 706. The carrier member has a mounting surface 708 between the first end 704 and the second end 706 onto which a bolt-on load-lifting fork 202 may be fastened and a reverse side 710 opposite to the mounting surface 708. The elongate carrier member has a plurality of fork-mounting bolt holes 702, each bolt hole 702 extending from the mounting surface 708 to the reverse side 710. The bolt holes 702 are generally spaced longitudinally along the elongate carrier member.

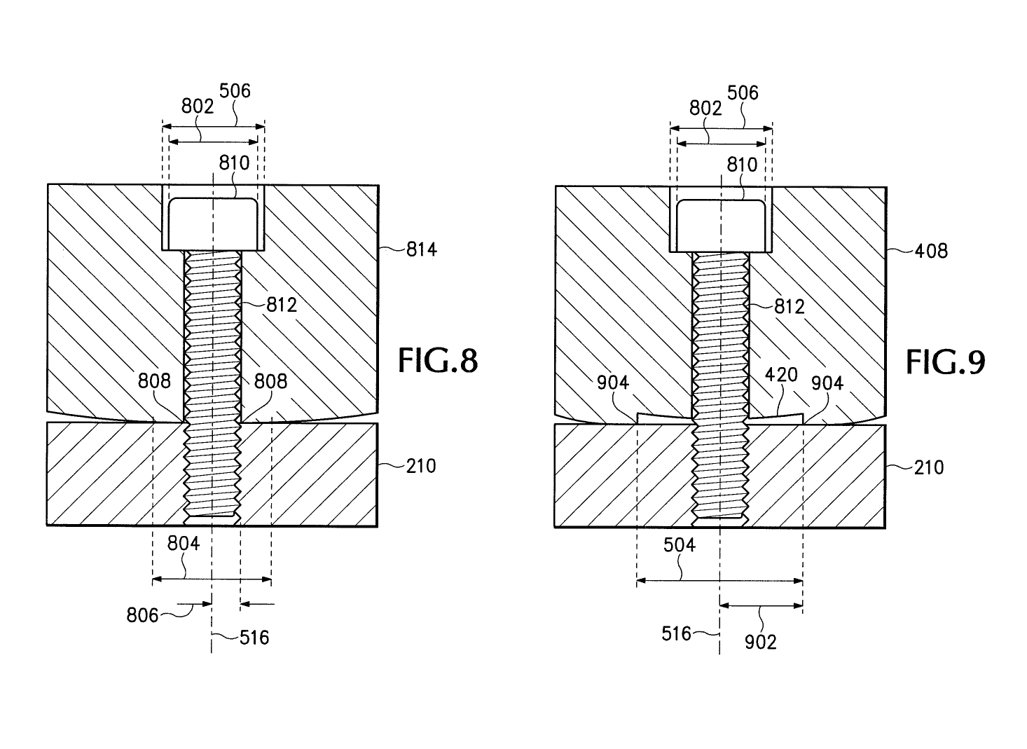

FIG. 7 also provides a perspective view depicting a space created by the back-side recessed area 426 when the shank 408 is joined to the carrier mounting surface 708. The bolted joint illustrated in FIGS. 7 will be discussed in greater detail with respect to FIGS. 8 and 9 for comparison purposes. FIG. 8 is a sectional view of a joint between a bolt-on fork without a recessed area, such as recessed area 426 as in FIG. 7, and a carrier. In contrast, FIG. 9 is a sectional view of a joint between a bolt-on fork having such a recessed area and a carrier.

FIG. 8 shows a fork mounting bolt having a bolt head 814 with bolt-head width dimension 802 and threads 812 extending into the carrier 210. The bolt-head width dimension 802 is less than the front-face recess (or counter-bore) width dimension 506 so that the bolt head fits within the front-face recess and can be rotated within the recess to securably fasten the shank 814 and carrier 210. Deflection in the joint is shown exaggerated so as to illustrate that the compressive loads are likely concentrated at joint surfaces under the bolt head 810 and closer to the centerline 516 of the bolt. The inventors believe that the compressive loads are distributed within a clamp load dimension 804 that extends radially outward from the centerline 516 of the bolt and that the compressive loads are generally focused at minimum fulcrum points 808 located immediately adjacent to the bolt threads 812 where the shank 814 comes into compressive contact with the carrier 210. Side loading of the fork may cause bending of the bolt with only a small resisting moment arm 806 (from the centerline of the bolt 516 to the minimum fulcrum 808). As reciprocating side loads are repetitively applied and released, the shank 814 may tend to rotate at the minimum fulcrum points 808 causing the threaded shaft 812 of the bolt to bend excessively back and forth.

In contrast, FIG. 9 shows a shank 408 that includes a back-side recess area 426 as shown in FIG. 7. The inventors believe that the compressive loads are distributed outside of the back-side recess width dimension 504 and that the compressive loads are generally focused at minimum fulcrum points 904 located radially far away from the bolt threads 812. Side loading of the fork may still cause bending of the bolt. However, a much larger effective moment arm 902 (from the centerline of the bolt 516 to the minimum fulcrum point 904) is available to resist such bending, thereby significantly reducing the reciprocating bending stresses on the bolt and reducing the likelihood of stress fractures.

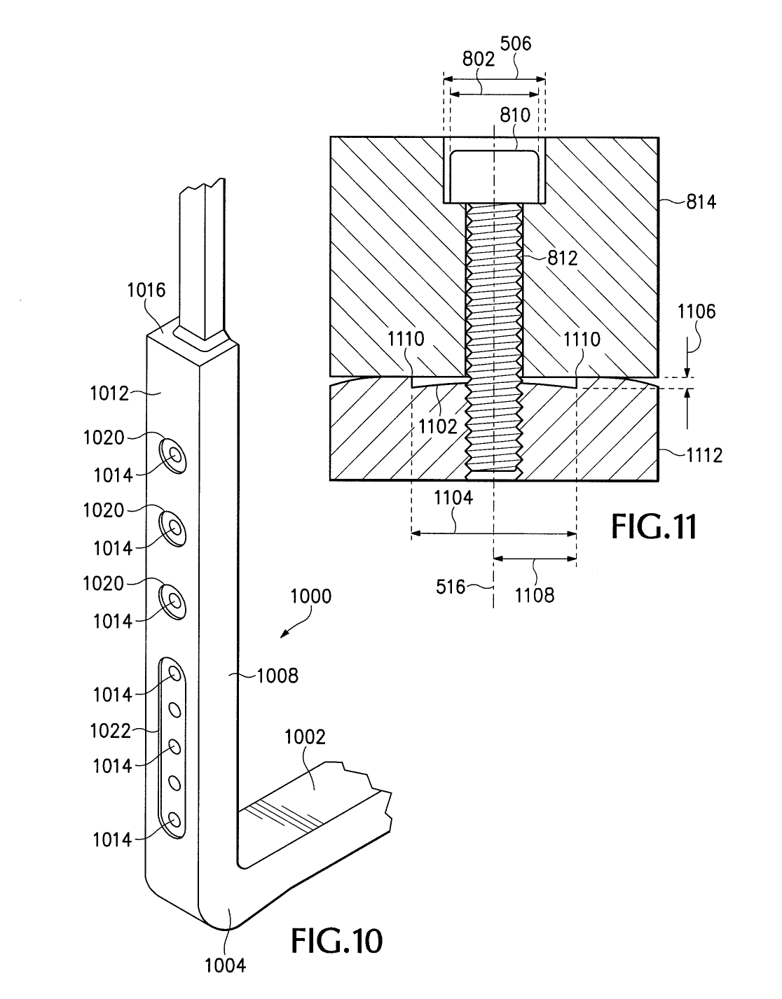

FIG. 10 is a perspective view of an exemplary bolt-on fork 1000 having a blade 1002, a heel portion 1004, and a shank 1008 extending longitudinally from the heel portion 1004 to a shank top 1016, all similar to the fork 202 in FIG. 4. The back side 1012 of the shank 1008 includes a plurality of fork-mounting bolt holes 1014, each extending from a respective back-side recessed area 1020 formed in the back side 1012 of the shank 1008 toward the front face of the shank 1008. In one embodiment, each of the bolt holes 1014 is associated with its own back-side recessed area 1020, not interconnected with the other recessed areas 1020 by any slot. All of the back-side recessed areas could be disconnected in this manner. Alternatively, some of the recessed areas could be part of an elongate slot 1022 extending longitudinally along the back side of the shank 1008, with the slot 1022 interconnecting such back-side recessed areas. For example, the slot 1022 shown in FIG. 10 is associated with five bolt holes 1014.

FIG. 11 is a sectional view of an exemplary joint between a carrier 1112, having a slot or recessed area 1102, and a bolt-on fork 814. As previously mentioned, the recessed area, whether positioned on the back side of the shank 814 or on the mounting surface of the carrier 1112 or both, creates a space between the back side and the mounting surface of the carrier, and the mounting bolt used for mounting the fork to the carrier passes through the space created by the recessed area. Therefore, the recessed area (or slot) may be positioned on either or both of the joined surfaces and still provide the advantages of the improved joint. The recessed area 1102 may have similar width 1104 and depth 1106 dimensions as the recessed area 426 described with respect to FIG. 5. Further, the recessed area 1102 may achieve the fulcrum displacement and lengthened resistive moment arm as described with respect to FIG. 9. That is, the recessed area 1102 may displace the minimum fulcrum points 1110 radially outward and lengthen the effective resistive moment arm 1108 to achieve the same benefits associated with a similarly dimensioned recessed area 426 described with respect to FIG. 9.

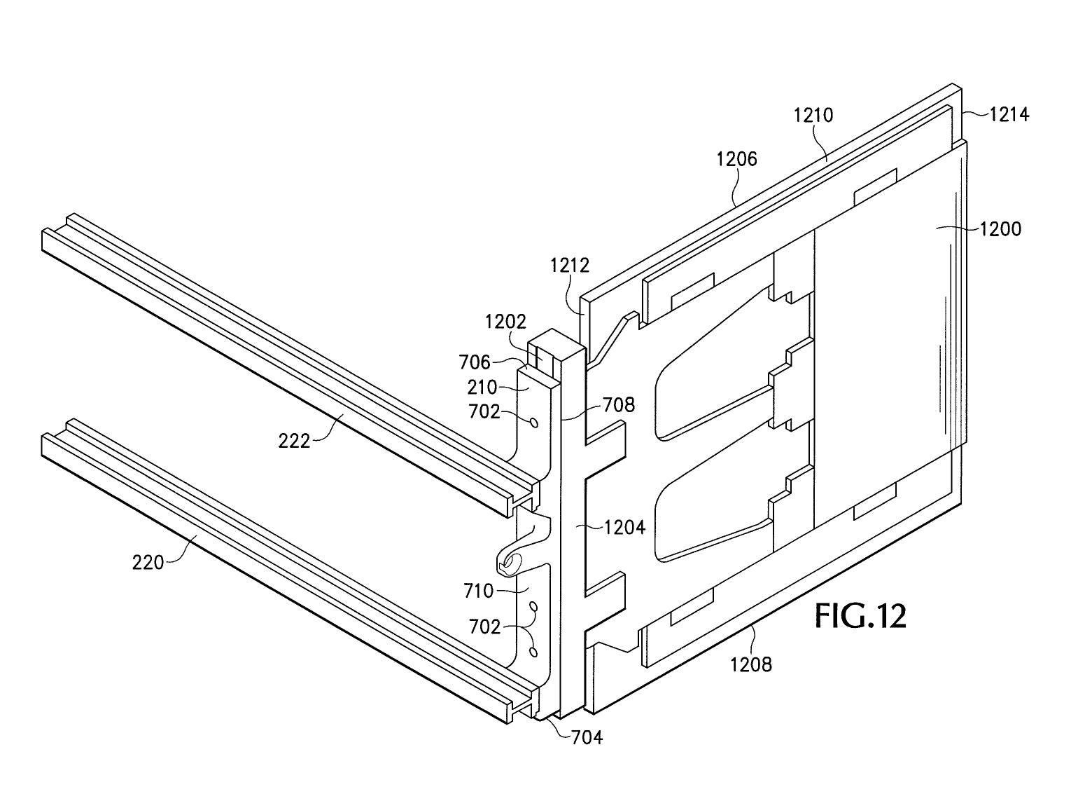

FIG. 12 is a perspective view of an exemplary bolt-on load clamp arm 1200 having interconnected recessed areas forming a slot. Load clamps are generally used for the palletless handling of unitized (i.e. boxed) loads and are typically designed for particular applications. For example, the load clamps may have load-engaging clamping pads sized for gripping the sides of a boxed appliance such as a refrigerator. Other load clamp configurations may be used for handling other types of loads. Typical carton clamps, for example, may be suitably sized for gripping the sides of stacked cartons.

As shown, the recessed area 1202 may have similar width and depth dimensions as the recessed area 426 identified in FIG. 5. Further, the joint between the carrier 210 and the shank 1204 may be similar to the joint in FIG. 7, and a sectional view through any of the bolt-holes 702 may be similar to the joint illustrated in FIG. 9. As shown in FIG. 12, the load clamp 1200 comprises a substantially planar load-engaging clamping pad 1206 that extends in a first direction from a lower edge 1208 to an upper edge 1210 and also in a second direction from a carrier-facing edge 1212 to an outward edge 1214. Although the pad 1206 is shown generally rectangular in shape, the pad 1206 may be configured in other shapes. Preferably, the elongate shank 1204 extending longitudinally from the lower edge 1208 to the upper edge 1210 is attached to the pad 1206 so that it is proximate or adjacent to the carrier-facing edge 1212.

In operation as a carton clamp, for example, the load clamp 1200 may have a leading or outward edge 1214 that may be inserted between cartons. Slide bar members 220, 222 may then be retracted in a direction toward an opposing load clamp arm (not shown) so as to clamp the load between the pair of pads. The cartons gripped between the opposing pads, for example, between the pad 1206 and the opposing pad (not shown), may then be lifted and moved by the pair of clamp arms.

The terms and expressions which have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims which follow.

I claim:

1. A bolt-on load-lifting fork comprising:
(a) an elongate blade upon which a load may be supported, the blade extending longitudinally from a heel portion to a tip;
(b) an elongate shank extending longitudinally from said heel portion in a direction substantially perpendicular to said blade, said shank having a front face which faces toward said tip of said blade and a back side opposite to said front face;
(c) said elongate shank having a plurality of fork-mounting bolt holes, each extending from a respective back-side recessed area formed in the back side of said shank toward said front face, said plurality of bolt holes being spaced longitudinally along said elongate shank;
(d) each of said bolt holes having a respective bolt-hole width dimension transverse to said elongate shank, and each said back-side recessed area having a back-side recess width dimension parallel to and greater than said bolt-hole width dimension.

2. The fork of claim 1 wherein at least one said back-side recessed area comprises a portion of an elongate slot extending longitudinally along said back side of said shank, said slot interconnecting said back-side recessed area with at least one other said back-side recessed area formed in the back side of said shank.

3. The fork of claim 1 wherein each of said bolt-holes communicates with a respective front-face recessed area formed in said front face and having a front-face recess width dimension parallel to and greater than said bolt-hole width dimension, each said back-side recess width dimension being greater than each said front-face recess width dimension.

4. The fork of claim 1 wherein said elongate shank has a shank width dimension parallel to said back-side recess width dimension, said bolt holes being substantially centrally located relative to said shank width dimension.

5. The fork of claim 4 wherein said back-side recess width dimension is substantially at least one-half as long as said shank width dimension.

6. A carrier comprising:
(a) an elongate carrier member extending longitudinally from a first end to a second end, said carrier member having a mounting surface between said first and second ends onto which a bolt-on load-lifting member may be fastened and a reverse side opposite to said mounting surface;
(b) said elongate carrier member having a plurality of mounting bolt holes, each extending from a respective mounting surface recessed area formed in the mounting surface of said carrier member toward said reverse side, said plurality of bolt holes being spaced longitudinally along said elongate carrier member;
(c) each of said bolt holes having a respective bolt-hole width dimension transverse to said elongate carrier member, and each said mounting surface recessed area having a mounting surface recess width dimension parallel to and greater than said bolt-hole width dimension.

7. The carrier of claim 6 wherein at least one said mounting surface recessed area comprises a portion of an elongate slot extending longitudinally along said mounting surface of said carrier member, said slot interconnecting said mounting surface recessed area with at least one other said mounting surface recessed area formed in the mounting surface of said carrier member.

8. The carrier of claim 6 wherein said elongate carrier member has a carrier member width dimension parallel to said mounting surface recess width dimension, said bolt holes being substantially centrally located relative to said carrier member width dimension.

9. The carrier of claim 8 wherein said mounting surface recess width dimension is substantially at least one-half as long as said carrier member width dimension.

10. A bolt-on load-lifting clamp arm comprising:
(a) a load-engaging clamping surface extending in a first direction from a lower edge to an upper edge and extending in a second direction from a carrier-facing edge to an outward edge, said second direction being substantially perpendicular to said first direction;
(b) an elongate shank extending longitudinally in said first direction, said shank attached to said load-clamping surface, said shank having a front face which faces toward said outward edge and a back side opposite to said front face;
(c) said elongate shank having a plurality of clamp arm-mounting bolt holes, each extending from a respective back-side recessed area formed in the back side of said shank toward said front face, said plurality of bolt holes being spaced longitudinally along said elongate shank;
(d) each of said bolt holes having a respective bolt-hole width dimension transverse to said elongate shank, and each said back-side recessed area having a back-side recess width dimension parallel to and greater than said bolt-hole width dimension.

11. The clamp arm of claim 10 wherein at least one said back-side recessed area comprises a portion of an elongate slot extending longitudinally along said back side of said shank, said slot interconnecting said back-side recessed area with at least one other said back-side recessed area formed in the back side of said shank.

12. The clamp arm of claim 10 wherein each of said bolt-holes communicates with a respective front-face recessed area formed in said front face and having a front-face recess width dimension parallel to and greater than said bolt-hole width dimension, each said back-side recess width dimension being greater than each said front-face recess width dimension.

13. The clamp arm of claim 10 wherein said elongate shank has a shank width dimension parallel to said back-side recess width dimension, said bolt holes being substantially centrally located relative to said shank width dimension.

14. The clamp arm of claim 13 wherein said back-side recess width dimension is substantially at least one-half as long as said shank width dimension.
